(19) United States
(12) Patent Application Publication
(10) Pub. No.: US 2016/0102025 A1
(43) Pub. Date: Apr. 14, 2016

(54) APPARATUS FOR THE PRODUCTION OF PLASMA-CATALYTIC ENHANCED WATER AND METHOD OF USING THE SAME

(71) Applicant: Advanced Plasma Solutions, Inc., Malvern, PA (US)

(72) Inventors: Thomas NUNNALLY, Philadelphia, PA (US); Jerome D. FRANK, Villanova, PA (US); Justine HAN, Princeton Junction, NJ (US); Vladimir DERGUNOV, Huntingdon Valley, PA (US)

(73) Assignee: Advanced Plasma Solutions, Inc., Malvern, PA (US)

(21) Appl. No.: 14/881,402

(22) Filed: Oct. 13, 2015

Related U.S. Application Data
(60) Provisional application No. 62/063,191, filed on Oct. 13, 2014.

(51) Int. Cl. C05C 5/00; C05G 3/00; C05C 11/00; A01N 25/02; B01J 19/08; A01N 59/00

(52) U.S. Cl. CPC C05C 5/00; B01J 19/088; A01N 59/00; C05C 11/00; A01N 25/02; C05G 3/0076; B01J 2219/0801; B01J 2219/0884; B01J 2219/0894; B01J 2219/0809; B01J 2219/0841; B01J 2219/0847; B01J 2219/0849; B01J 2219/0869

(57) ABSTRACT

A water processing system is provided for providing plasma-catalytic enhanced water that contributes to improved yield and growth of plants. The system may include a plasma power supply configured to initiate the plasma and regulate the plasma discharge current of a plasma discharge, a plasma discharge reactor connected to the plasma power supply and configured to generate the plasma discharge, a pump connected to a water source and configured to deliver water to a nozzle configured to spray water into the plasma discharge, a compressor connected to a gas source and configured to deliver a gas for the plasma discharge, and collector to collect the water after the water has passed through the plasma discharge. Methods of making and applying the plasma-catalytic enhanced water are also provided.

### CROSS-REFERENCE TO RELATED APPLICATION

The present application claims priority to U.S. Provisional Application 62/063,191 filed on Oct. 13, 2014, the entire contents of which are incorporated herein by reference in its entirety.

### FIELD OF THE INVENTION

The present invention is directed to a plasma discharge reactor, and specifically, a plasma discharge reactor designed to provide plasma-catalytic enhanced water that is useful for increasing plant growth and yield.

### BACKGROUND

With increasing populations and decreased crop acreage, providing adequate resources, particularly food, is becoming not only an economic issue, but a moral issue as well. One way to address this issue is by increasing the efficiency of farmlands through increased plant growth and yield. Innovative solutions are needed to address this challenge.

A number of variables affect plant development and growth. One factor, which plays a particularly important role, is water chemical composition. More specifically, water pH and nutrient content, play a crucial role in plant development and growth. Today, soil pH and nutrient content are controlled through the addition of various fertilizers that contain necessary buffers and nutrients. These fertilizers, however, suffer from drawbacks such as slow and unbalanced nutrient delivery, untidy application, and undesired runoff.

Thus, there is a need for improved methods and technologies for the production and delivery of chemically enhanced water to improve crop growth and yield.

### SUMMARY OF THE INVENTION

It is an aspect of the present invention to provide a water processing system comprising
a plasma power supply configured to initiate the plasma and regulate the plasma discharge current,
a plasma discharge reactor connected to the plasma power supply and configured to generate the plasma discharge,
a water source containing water,
a pump connected to the water source and configured to deliver the water to a nozzle, the nozzle configured to spray water into the plasma discharge,
a gas source containing a gas comprising oxygen and nitrogen,
a compressor connected to the gas source and configured to deliver the gas for the plasma discharge, and
a plasma-catalytic enhanced water collector configured to collect the water after the water has passed through the plasma discharge,
   wherein the water in the plasma-catalytic enhanced water collector contains a greater concentration of nitrate than the water in the water source.

It is another aspect of the present invention to provide a method of making plasma-catalytic enhanced water comprising
supplying a gas containing nitrogen and oxygen to a plasma discharge reactor to generate a plasma discharge,
regulating the current of the plasma discharge with a plasma power supply, and
delivering untreated water through a nozzle and the plasma discharge to form a plasma-catalytic enhanced water containing at least one of nitrate, nitrite, hydroxyl groups, hydrogen peroxide, ozone, and peroxynitrate.

It is yet another aspect of the present invention to provide a method of increasing plant growth or yield comprising producing a plasma-catalytic enhanced water and delivering the plasma-catalytic enhanced water to one or more plants.

These and other aspects of the Invention will be apparent from the detailed description below.

### BRIEF DESCRIPTION OF THE FIGURES

FIG. 1 is schematic diagram of a first embodiment of the present invention;

FIG. 2 is a graph of the concentration of species, temperature, and nitrate concentration as a function of time over 5 hours with an Inset graph demonstrating the pH trends over the same period of the values provided in Table 1;

FIG. 3 is a graph of pH and nitrate concentration as a function of specific energy input for water;

FIG. 4 is a graph of pH and nitrate concentration as a function of specific energy input for air at a constant specific energy input for water;

FIG. 5 is a graph of pH and nitrate concentration as a function of specific energy input for water at a constant specific energy input for air;

FIG. 6 is a graph of pH and nitrate concentration at varying specific energy input for water at three values of specific energy input for air;

FIG. 7 is a graph of voltage and current measurements for a low specific energy input, high air flow rate regime;

FIG. 8 is a graph of voltage and current measurements for a high specific energy input, low air flow rate regime;

FIG. 9 is a graph of a 100 micro second data set at low specific energy input and high air low rate;

FIG. 10 is a schematic of a hybrid plasma discharge produced in another embodiment of the present invention;

FIG. 11 is a top perspective view of a Mobile Plasma-catalytic Enhanced Water Production Unit according to yet another embodiment of the present invention;

FIG. 12 is a photograph of the Mobile Plasma-catalytic Enhanced Water Production Unit of FIG. 11; and

FIG. 13 is a photograph of several cannabis sativa grown using plasma-catalytic enhanced water (left) and tap water (right).

### DETAILED DESCRIPTION OF THE INVENTION

According to various embodiments of the present invention, a system and method are provided for the production of plasma-catalytic enhanced water that may be used for agricultural plant management. The system may include a water source that is fed into a plasma discharge with a gas. The gas preferably comprises nitrogen and oxygen. While in the plasma discharge, the chemical composition of the water is enhanced through plasma-catalytic effects, creating a plasma-catalytic enhanced water. The plasma-catalytic enhanced water then exits the plasma discharge and Is collected in a receiver, which stores the plasma-catalytic enhanced water, or alternatively, the water may be immediately provided for application to one or more plants through a water delivery system. The plasma-catalytic enhanced water made according to various embodiments of the present invention may be used as a feedstock on plants to stimulate growth, reduce water feed requirements, and reduce abiotic and biotic stresses in plants, such as pathogens, bacterium, fungi, and viruses. The system in some embodiments of the invention may be provided as a single mobile water processing unit comprising a water source, an air source, a plasma power supply, a plasma discharge reactor, and a water receiver/delivery system.

The systems and methods according to the present invention allow for the control and delivery of a plasma-catalytic enhanced water feedstock with ideal quantities of pH, nitrate, nitrite, hydrogen peroxide, peroxynitrate, and other hydrogen, oxygen and nitrogen containing compounds, ions, radicals and active species. When oxygen and nitrogen containing gases are supplied to a plasma generator according to the present invention, the plasma discharge generates high concentrations of reactive oxygen and nitrogen species, charged chemical constituents, and UV radiation. The reactive species serve to defend against pathogens, bacterium, fungi, and viruses present in the water. In addition, reactive oxygen and nitrogen species present in the plasma-catalytic enhanced water produced according to the present invention may also reduce pathogen load in the soil when delivered to the root system of plants.

Direct delivery of nitrite and nitrate to a plant root system may obviate the need to regulate soil microflora and reduce the temperature requirements for plant germination and growth. Bacteria are needed to be present in soil to digest ammonia-based fertilizers and produce the nitrate required by the plant. For this reason, soil temperature needs to be appropriate for bacteria survival and growth (˜50 F). Because nitrate may be produced and incorporated in the plasma-catalytic enhanced water made according to the present invention, the nitrate may be delivered directly into the soil, thereby eliminating or reducing the need for bacteria and reducing the temperature requirements for plant germination and growth. The active ionic species provided by plasma treatment will also impact surface interactions with soil, potentially improving water retention between liquid-particle surfaces.

The water processing systems according to various embodiments of the present invention may be provided as a point-of-use system to process onsite water into enhanced water having antimicrobial activity that is better retained by plants and increase growth. The systems and methods according to the present invention may reduce and potentially eliminate the need for fertilizers and improve the rate of germination and nutrient up-take by plant seeds and developing plants. Furthermore, the use of the plasma-catalytic enhanced water made using the systems and methods of the present invention may result in faster germination, improved growth rate, and improved yields. The chemical composition of the plasma-catalytic enhanced water according to various embodiments of the present invention may be obtained by varying plasma parameters such as plasma power, water flow rate, plasma gas flow rate and plasma gas composition, which may provide plasma-catalytic enhanced water with properties suitable for a variety of different applications.

The systems and methods according to the various embodiments of the present invention utilize a plasma discharge to produce plasma-catalytic enhanced water. An ionized gas is referred to as plasma when its electron density is balanced by that of positive ions and it contains a sufficient amount of electrically charged particles to affect its electrical properties and behavior. Plasma discharges exist in a wide range of conditions, and their particular properties depend on a variety of parameters including pressure, temperature, and density.

Generally, plasma is separated into two main temperature regimes, non-thermal and thermal, either of which may be utilized in the systems of the present invention. Plasma can be separated into multiple regimes as defined by the difference in electron and ion temperatures and the balancing of energy transport processes. The measure of the kinetic energy of a gas constituent, and thereby defining the temperature of the gas and/or its constituents, is the summation of translational, rotational, vibrational and electronic energy. When the mean kinetic energy (temperature) of the ions is equal to the mean kinetic energy (temperature) of the electrons in the plasma, the plasma is said to be in Thermal Equilibrium; if the relationship is valid only on a small scale and not globally, the plasma can be considered to be in Local Thermal Equilibrium. In the case where the mean electron kinetic energy is significantly higher than that possessed by the ions, the plasma is said to be a non-equilibrium plasma. The embodiments of the present invention may form a plasma that can by described by any of these regimes or any combination of plasma regimes. Such energies are achieved via electron-electron collisions and electron collisions with heavy particles, which result in Ionization of the heavy particles. Depending on the frequency of collisions, the energy (and hence temperature) of plasma components (electrons and heavy particles) can be different. As a result, the plasma can exist in a non-equilibrium state.

In non-thermal plasma, electron temperature is highest (usually 10,000K or 1 eV); however, rotational excitation temperature, ion temperature, and heavy particle temperature, or the bulk gas temperature, are all quite low (room temperature). Under such conditions, high energy electrons lead to the formation of active chemical species and radicals, such as atomic oxygen (O) and hydroxyls (OH), and electronically excited oxygen (¹O₂). It is these plasma-generated radicals and Ions that behave like catalysts, and participate in chain reactions that promote or accelerate reaction pathways. Thermal plasma, however, is often characterized by temperature equilibrium, where the temperature of all energy levels and components are nearly equal. In thermal plasma, the joule heating effect results in high gas temperature. In thermal plasmas, energy is used to heat the entire gas, and temperatures often range from 10,000-100,000K (10-100 electron volts (eV)).

Various types of plasma discharges may be incorporated in the water processing systems according to the present invention. The types of plasma discharges include, but are not limited to, glow discharges, corona discharges, Dielectric Barrier Discharges, arc discharges, gliding arc discharges, microwave discharges, and radio-frequency discharges.

The glow discharge is the most well-known type of non-thermal plasma known to those of skill in the art. It can be described as a self-sustained continuous DC discharge with a cold cathode, which emits electrons as a result of secondary emission. Glow discharge has distinct features such as: a cathode layer (a positive charge space with strong electric field), a positive column (a quasi-neutral plasma with low electric field located between the cathode and anode), and an anode layer (a negative charge space with slightly elevated electric field). A normal glow discharge operates in a current regime of 10⁻⁴-0.1 A. Any increase in current above this regime will result in a transition to an abnormal glow discharge. Increasing current further (1 A) will result in a transition to an arc discharge.

The corona discharge is also very well known, manmade and naturally occurring plasma discharge. It can be described as a weakly luminous, non-uniform discharge, which appears at atmospheric pressure near sharp points, edges, and along thin wires. Strong electric field and Ionization along with some luminosity are located near one electrode. The charged particles are then carried by weak electric fields from one electrode to another. Corona discharges can be both positive and negative. Another form of corona discharge is the pulsed corona discharge. Continuous corona discharges are limited by low current and power, which results in more application for materials and gas streams, such as environmental and fuel conversion applications. It is possible to increase power in a corona discharge without transition to the spark regime by using pulse-periodic voltage. Pulsed corona can be relatively powerful (10 kW) and quite luminous. The most typical corona configuration (both pulsed and continuous) is created around a thin wire, which maximizes the active discharge volume. For corona discharges, a non-homogeneous electric field is used to stabilize the discharge via the buildup of space charge around a corona wire or point.

Dielectric Barrier Discharge (DBD) is similar to pulsed corona, in that its development was a result of trying to find a solution for avoiding spark formation. In the case of DBD, a dielectric barrier is used to stop current and prevent spark formation. The DBD electrode gap includes one or more dielectric layers, which are located in the current path. Gap distance is typically in the range of 0.1 mm to several centimeters. Some of the dielectric materials that can be used are glass, quartz, and ceramic.

The arc discharge is an ionized channel of gas in what is normally non-conducting medium such as gas. Arc discharges have been used for many industrial and commercial applications including metallurgy, waste disposal, lighting applications, and Ignition systems in vehicles. They are high-current (30 A or above), low-voltage (10-100V) discharges, which have very high gas temperatures (10,000 degrees K and above or 10 eV and above). The high gas temperature is due to the high degree of joule heating from the discharge current. Their initial high temperature also contributes to sustaining high current by influencing the mechanism by which electrons are supplied to the discharge, namely the thermionic and field emission mechanism. Thermionic emission is electron emission from a high temperature metal surface due to the high thermal energy of electrons in the metal. For this process to occur, a combination of high metal surface temperature must be coupled with sufficient external electric field in the cathode vicinity. This permits a large number of electrons to escape the metal surface and provides a high flux of current into the discharge. The high temperature of arc discharges can lead to problems such as evaporation and electrode erosion. These problems can be partially mitigated by actively cooling the electrodes. Unfortunately, arc discharges have the significant drawback of high operational electrical energy cost.

A conventional gliding discharge, traditionally called gliding arc (GA) is an auto-oscillating periodic phenomenon that develops between at least two diverging electrodes submerged in a laminar or turbulent gas flow. First, the discharge self-initiates at the upstream narrowest gap in what is termed the breakdown stage. Then, the discharge forms a plasma column connecting the electrodes of opposite polarity, which is termed the equilibrium stage. This column is dragged by the gas flow towards the diverging downstream section. The discharge length grows with the increase of inter-electrode distance until it reaches a maximum possible value, usually determined by the power supply limit. The non-equilibrium stage starts when the length of the gliding arc exceeds this critical value. Heat losses from the plasma column begin to exceed the energy supplied by the power source, and it is not possible for the discharge to remain in equilibrium. At this point, the plasma rapidly cools and decays. After this point, the discharge extinguishes and momentarily reignites itself at the minimum distance between the electrodes, starting a new cycle.

Microwave discharges have the great advantage of being capable of operation without electrodes. Instead of utilizing a potential difference between electrodes, a microwave discharge is sustained by a high frequency electromagnetic field. Operation without electrodes is often preferred for high temperature applications because it may eliminate the need for complicated electrode cooling. Initiating high frequency plasmas, however, is more challenging than traditional DC plasmas because microwave requires more complex, expensive power supplies along with additional components such as a frequency generator (magnetron head), a circulator, a tuner, a directional coupler, a waveguide. In addition, the plasma must be coupled as a load in the power circuit. In general, this coupling is accomplished via waveguides, where a quartz tube is inserted into the waveguide. The plasma is ignited and confined to the quartz tube. Microwave discharges may exist as both thermal and non-thermal discharges. Thermal microwave plasma discharges operate at atmospheric pressure, while non-thermal microwave operates at low pressure. The thermal properties of microwave plasma will generally increase as pressure is increased.

Radio frequency (RF) discharges share many similar properties with microwave discharges. RF discharges operate without electrodes (only in the 0.1 to 100 MHz region) and can exist in both thermal and non-thermal regimes that are pressure dependent. Thermal plasma generation is provided via inductively coupled plasma (“ICP”) at atmospheric pressure. In this case, high frequency current passes through a solenoid coil, providing a magnetic field. This allows for the formation of a vortex electric field, which sustains the RF ICP discharge. Again, expensive power supplies and additional components may be required, and the plasma should be coupled as a load with an RF generator. Effectiveness of coupling the electromagnetic field to the plasma discharge is desirable because the plasma is sustained by the energy absorbed by the field. Poor coupling will result in low efficiency of the power supply. At low pressures, RF plasma can exist in a strongly non-equilibrium regime. In this regime, the capacitively coupled plasma (CCP) can be utilized. RF CCP operates with higher electric fields. As a result, RF CCP discharges are more non-thermal than ICP and can generate non-thermal plasma at moderate to high pressures.

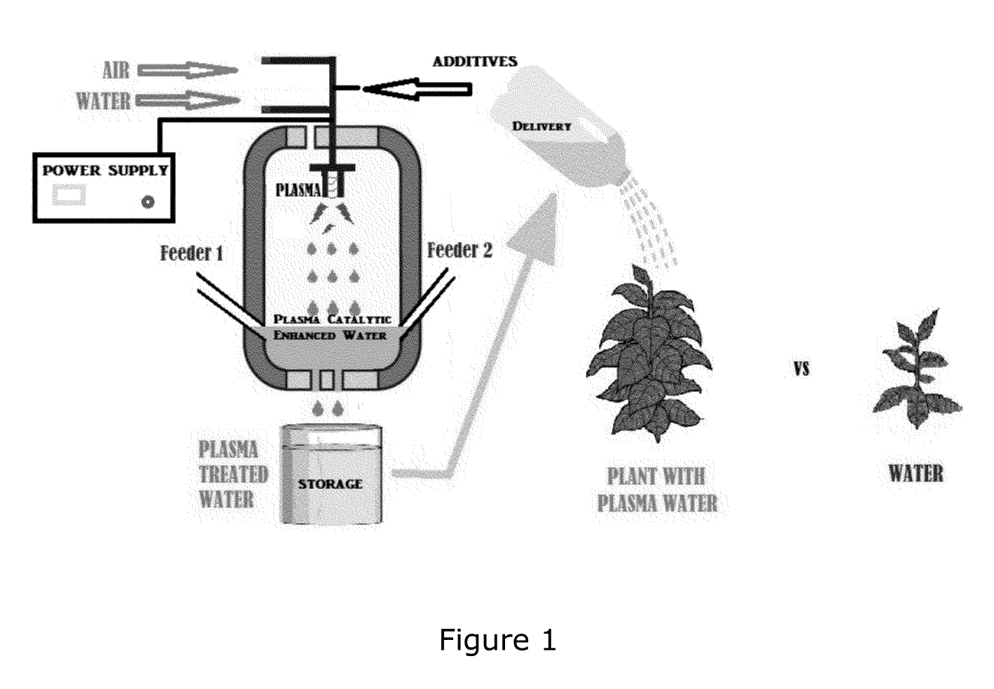

Referring now to FIG. 1, a schematic of a system according to one embodiment of the present invention is provided. The system may include a power supply that delivers current to electrodes located within a reactor to generate a plasma discharge. Water from a source is fed into the plasma discharge with a gaseous composition including nitrogen and oxygen, such as air. While in the plasma discharge, the chemical components of the water and air react forming a plasma-catalytic enhanced water having components that are particularly useful for plants. The now plasma-catalytic enhanced water then exits the plasma charge and is stored in a receiver. This enhanced water can then be used as a feedstock on plants to stimulate growth and Increase plant yield. The system may comprise a single water processing unit including: a water pump, an air compressor, a plasma power supply, a plasma discharge reactor, and a water receiver. As will be described in greater detail below, the system may optionally include an inlet to introduce additional additives into the water composition. The Inlet may be provided to the water or air source prior to the plasma discharge or alternatively, through one or more feeders after the plasma discharge. A filter on the input may be required to protect the pump, and a filter may be needed at the output to remove particulate matter from the treated water.

The water source included in various embodiments of the present invention may be one of any number of water sources including, but not limited to, tap water, spring water, deionized, or distilled water. Water sources commonly used in the agriculture industry are the preferred sources of water for the system and methods according to the present invention. Depending on the application and location, delivery of the water may require extra equipment to transmit the water to the system or from the system. A water pump may provide the pressure necessary to pump the water into the plasma discharge. As understood by one of skill in the art, the pump should be scaled to meet the requirements associated with the volume of water needed for a given application.

The gas used to form the plasma discharge in the system according to the present invention includes oxygen and nitrogen. Air is the preferred gas for discharge formation. The gas may be provided to the system via multiple sources using equipment known to those of skill in the art, such as an air compressor, for example. A compressor may provide the condensed gas flow necessary to create the plasma discharge. Once the discharge is established, the compressed gas provides the supply of nitrogen and oxygen that will react to form a variety of Ions, radicals, compounds, and excited species. The compressor may be used to control flow rate to provide an optimal balance of chemical reactions and plasma discharge.

In order to provide the optimal balance of chemical reactions with the plasma discharge, the systems according to various embodiments of the present invention may also include an additive addition stage. The additives may include, but are not limited to, any noble gas, oxygen, nitrogen, gaseous H₂O, fertilizer based gases containing potassium-, nitrogen-, or phosphorus-containing compounds, liquid H₂O, H₂O₂ and fertilizer based liquids containing potassium-, nitrogen-, or phosphorus-containing compounds, and solids such as fertilizer based containing potassium-, nitrogen-, or phosphorus-containing compounds. These additives may be added, for example, before the plasma discharge as additives to the Input gas or additives to the Input water, directly in the plasma discharge region, directly in the post plasma discharge region, or directly to the produced water. The ratio of the input air and water to the additives may be modified depending on the desired plasma-chemical reactions, as well as the type and amount of compounds in the enhanced water composition, thereby allowing a user to tailor the system for a specific application.

In order to initiate, maintain, and control a plasma discharge, a plasma power supply is provided in the system according to the present invention. The plasma power supply provides the breakdown voltage needed to initiate a plasma discharge. Furthermore, the plasma power supply may regulate the current or power of the discharge, which permits stable operation at the settings for a particular discharge. Power supplies are unique to the discharge that they are sustaining. The types of power supplies that may be incorporated in the system of the present invention include, but are not limited to, line connected, reactance modulated supplies, any switching power supply, including both hard and soft switched schemes. The embodiments of the present invention may also incorporate any of the aforementioned topologies in combination with or without rectification. As explained above, the plasma discharge may be one of any number of discharges including, but not limited to, spark, arc, transferred arc, corona, DBD, gliding arc, microwave, radio-frequency, and glow discharge. A preferred plasma power supply should be capable of controlling the output current during operation. This can be accomplished with line reactors, resonant power supplies or PWM (Pulse Width Modulation) techniques, such as phase-shift, resonant, or hard switched modulators. If the supply current is not controlled through resonance, the power supply should use a defined reactance in either the primary or secondary circuit. The preferred embodiment utilizes a hard switched H-bridge, PWM topology. The power supply must also supply sufficient voltage to initiate the plasma. This can be accomplished by a pulsed, high-voltage power supply that is diode “ORed” into the circuit, or by means of resonant charging. In the preferred embodiment, resonant charging is used to initiate the plasma.

The topology of the power supply is best understood as a constant current source as the plasma voltage is a dependent effect of many other inputs. Preferably, this supply should be capable of producing variable output current so that the supply can be matched to the operational demands of different arrangements of feedstock input (working gas, gas volume, aerosol droplet size, the chemical composition of feedstock, etc.) and plasma chemistry products. The supply also must have sufficient voltage to initiate plasmas in all desired reactor geometries and the capability to control the current so that thermal equilibrium plasma generation is minimized. In a preferred embodiment, a plasma power supply will produce up to 15 kV initiation pulses, more preferably 6 to 10 kV, and be controllable up to 15 A, more preferably 2 to 10 A, and produce current with better than 10% regulation. The output may be pulsating DC, steady-state DC, or AC, preferably steady-state DC.

In a preferred embodiment of the present invention, the water processing system comprises a hybrid plasma discharge. The hybrid plasma discharge may include two simultaneous plasma discharges, such as a gliding arc discharge and a corona discharge, which provide optimal conditions for production of plasma-catalytic enhanced water for the agriculture industry. For agricultural applications, the plasma discharge should cause the following chemical reactions:
1) The plasma-chemical production of NO and NOx.
2) The plasma-chemical production of ozone.
3) The plasma-chemical production of reactive species including (but not limited to) OH, HO₂, and O³P.

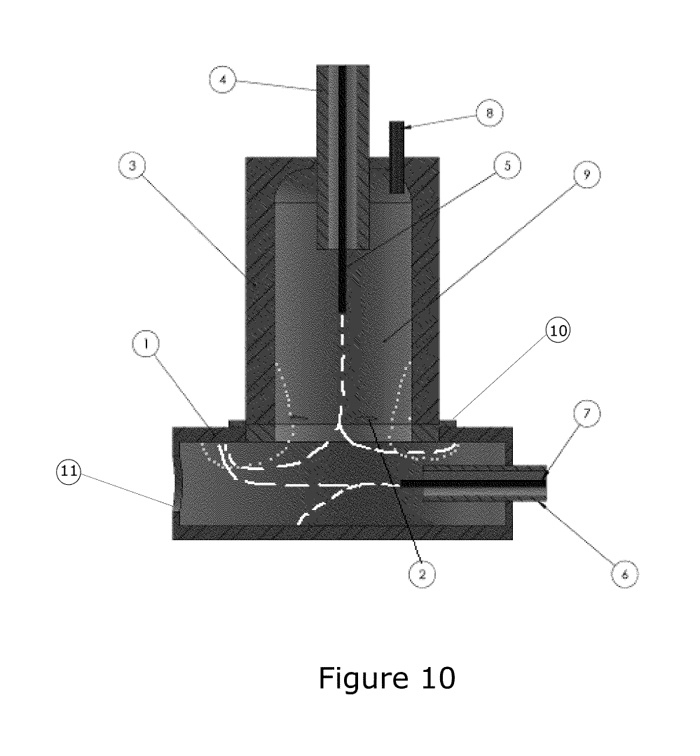

It has been found that the above chemical reactions may be easily induced by hybridizing two different plasma discharges. While not wishing to be bound to theory, it is believed that different plasma discharges are more efficient at stimulating specific plasma-chemical reactions. In the case of producing enhanced water for agricultural applications, this hybridization takes the form of one discharge optimized for production of NO and NOx and another discharge optimized for the production of ozone, hydroxyl, and peroxynitrate. While these discharges could take many forms, the preferred plasma discharges included in the hybrid plasma discharge are (1) a gliding arc discharge, and (2) a corona discharge. A schematic of the preferred design for reactor providing the hybrid plasma discharge is provided in FIG. 10. The dimensions of the plasma reactor may be scaled according to the desired water input and/or plasma-catalytic enhanced water output. For example, a plasma reactor capable of treating approximately 10 gallons per hour of water may having an internal reactor volume of 0.1 to 100 cm³, more preferably 0.1 to 20 cm³, most preferably 0.5 to 10 cm³. The reactor may be fabricated from any material known by those of skill in the art. In certain embodiments of the present invention the reactor may be made of stainless steel.

As explained above, the conventional gliding arc starts as an electrical breakdown in a narrow gap between two diverging electrodes in a gas flow. When the electric field in this gap reaches approximately 3 kV/mm in air, the air in the gap becomes ionized and is said to have “broken down.” The output voltage of the power supply causes a rapid increase plasma current until the plasma enters a negative resistance regime. In this regime, increasing current will cause the plasma voltage to decrease. If the gas flow is strong enough, it forces the arc to move along the diverging electrodes and to elongate. By forcing the arc to elongate, the arc is cooled through conductive and convective mechanisms and through black body radiation as the surface area increases. Cooling the arc causes the plasma voltage to rise. If the power supply is configured for constant current, the output current of the power supply rises to maintain the current and thereby allows the plasma voltage to increase. If the power supply is configured for constant arc power, the current is increased by increasing the output voltage. Maximum power is delivered at the point where the product of the current and voltage is maximized. The plasma will be extinguished when the power supply can no longer supply enough current or power to maintain the plasma channel gas temperature and thereby its conductivity. At that point, the power supply output voltage must rapidly rise to the breakdown voltage of the initial gap, thus restarting the cycle.

As a result of the above mentioned qualities, the gliding arc exists in both thermal and non-thermal regimes, which contribute to unique plasma chemistry and is ideal for providing NO and NOx in the hybrid plasma discharge. For example, the gliding arc may provide NO and NOx through both thermal and non-thermal pathways as follows:

N₂+O₂→2NO

N₂+e⁻→2N+e⁻,

O₂+e⁻→2O+e⁻,

N+O→NO.

This formation occurs in the higher temperature zone of the hybrid discharge (white dashed line in FIG. 10), which is necessary for NO and NOx production.

Gliding arc discharges may also produce NO₃⁻, NO₂⁻, OH⁻, O₃, H₂O₂, peroxynitrate, and other oxygen and nitrogen containing radicals and active species, when a discharge utilizes nitrogen, oxygen and water as media. In the embodiment in FIG. 10, the gliding arc is shown with a white dashed line and is formed between the high voltage (HV) and ground electrode via tangential gas injection of air and/or water. In the plasma reactor of FIG. 10, vertical cylindrical gliding arc HV electrode 3 is arranged perpendicular to a ground electrode 1 that may also be cylindrical. The gliding arc HV electrode 3 and ground electrode 1 may be separated by a dielectric material 10. The gliding arc HV electrode may also include one or more gas inlets 2. In the embodiment of FIG. 10, the inlets 2 include a plurality of pinholes about the circumferential wall of the gliding arc HV electrode 3 and are configured such that the gas will be directed tangentially relative to the circumferential inner surface of the HV electrode 3. Inserted through the vertical axis of the gliding arc HV electrode 3 is a corona HV electrode 5. The corona HV electrode 5 may be inserted through a water nozzle 4 that is also inserted through the vertical axis of the gliding arc HV electrode 3. The corona HV electrode 5 may or may not be inserted coaxially with the nozzle 4. The nozzle 4 provides an axial input of water and/or air and/or additives into the gliding arc HV electrode. A second optional nozzle 6 and corona HV electrode may be inserted axially through the ground electrode 1. The configuration of the nozzle 6 and corona HV electrode 7 may be similarly configured as the first axial input in the gliding arc HV electrode 3. The power needed to generated the plasma discharges may supplied to the reactor through a power supply high voltage connection 8. Upon being injected into a plasma zone 9, the water, air, and/or additives may exit through an outlet 11 of the ground electrode 1.

Corona discharges have low specific power and concomitantly low bulk gas temperatures. High concentrations of ozone in a corona discharge may be achieved with increased residence time of gas in the discharge zone. A large pulsed corona volume also leads to effective convective gas mixing in the plasma discharge and high heat transfer to the walls of the plasma discharge chamber. As a result, the system does not overheat, and the stability of the synthesized ozone is preserved. Therefore, the corona discharge may comprise the primary ozone generating portion of the hybrid plasma discharge, while also contributing hydroxyl, and other oxygen and nitrogen containing radicals and active species. For example, the corona discharge can exist in the low temperature zone of the hybrid plasma discharge (light-gray dotted line in FIG. 10), and ozone and hydroxyl production occurs primarily through the following mechanism:

O+O₂+M→O₃+M,

H₂O+e⁻→H+OH*+2e⁻

In the embodiment in FIG. 10, the corona discharge is schematically shown using the light-gray dotted lined; however, the corona discharge could be initiated in a number of locations within the reactor. Air is injected around the HV electrode and forms the plasma gas, which results in ozone formation. The produced ozone then passes through the gliding arc plasma zone, which it participates in chemical reactions with NO and NOx formed in the gliding arc discharge to form nitrogen containing compounds through pathways such as (but not limited to):

2NO₂+O₃→N₂O₅+O₂

N₂O₅+H₂O→2HNO₃

NO+OH+M→HNO₂+M

NO₂+OH+M→HNO₃+M

The embodiment also includes optional air and/or water addition through nozzle 4, which can stimulate further plasma-chemical reactions. The HV and ground portions of the system may be separated with dielectrics.

The plasma reactor according to various embodiments of the present invention may include electrodes may from one or more of a variety of metals. Preferably, the metal or metal alloy is selected, so that it is suitable for contact with water and may provide material specific benefits depending the Intended application. Specific examples include, but are not limited to:
a) gold-plated metal electrodes: gold oxide is non-toxic to plant cells and will not adversely affect the liquid;
b) titanium electrodes: titanium oxide is non-toxic to cells and toxic to many pathogens;
c) stainless steel electrodes: extremely durable electrodes having a long functional life-span and resist corrosion;
d) silver-plated metal electrodes: silver ions are known to be antimicrobial, and
e) refractory metals, such as elemental and alloyed tungsten, molybdenum, niobium, tantalum, rhenium and zirconium.

In order to inject water in the plasma discharge, the systems according to embodiments of the present invention may utilize a nozzle. The nozzle is preferably an atomizing nozzle to supply the water in the form of water droplets, which exhibit very high surface area, into the plasma reactor. Types of nozzles may include, but are not limited to, an ultrasonic atomizer, Plain-orifice nozzle, Shaped-orifice nozzle, Surface-impingement single-fluid nozzle, Pressure-swirl single-fluid spray nozzle, Compound nozzle, Internal-mix two-fluid nozzles, and External-mix two-fluid nozzles. The nozzle may be selected based a number of variable including, but not limited to, the scale of water production and the desired water surface area in the plasma zones. The nozzle should also be configured to direct the spray through the plasma zone of the reactor. If the spray angle of the nozzle is too large, the water may be directed towards the side walls of the electrodes in the plasma reactor. This will allow the water to avoid treatment by cascading along the Inner surfaces of the reactor and around the plasma zone. It is preferred that a spray angle is selected such that at least half of the flow rate of water passes through the plasma zone, more preferably substantially all of the water should pass through the plasma zone of the reactor.

In various embodiments of the present invention, water and/or gas may be injected tangentially, axially, or both tangentially and axially in the plasma reactor, relative to the orientation of the HV and/or ground electrode. In the preferred embodiment of the invention, the water and gas may be injected tangentially, axially or both tangentially and axially to the gliding arc, corona, or to both the gliding arc and corona in any order or iteration. Water is preferably introduced in a manner that maximizes surface area contact with the plasma discharge and the gas, preferably air, is preferably introduced in a manner that maximizes air velocity.

In one embodiment, the water may be introduced axially through a nozzle and treated by corona discharge, followed by treatment in the gliding arc discharge where air may be injected tangentially to form a vortex, followed by exhausting of the treated products out of the plasma reactor. In another embodiment, the water may be introduced axially through a nozzle, treated by gliding arc where air is injected tangentially to form a vortex, followed by treatment of the products by corona discharge, followed by exhausting of the treated products out of the plasma reactor. In yet another embodiment, air and water may be injected tangentially into the gliding arc discharge, followed by treatment of the products by corona discharge, followed by exhausting of the final products out of the plasma reactor. In yet another embodiment, air and water may be injected tangentially, an additional air supply may be injected axially, and the air and water may be simultaneously treated by gliding arc discharge and gliding corona discharge followed by exhausting of the final products out of the plasma reactor.

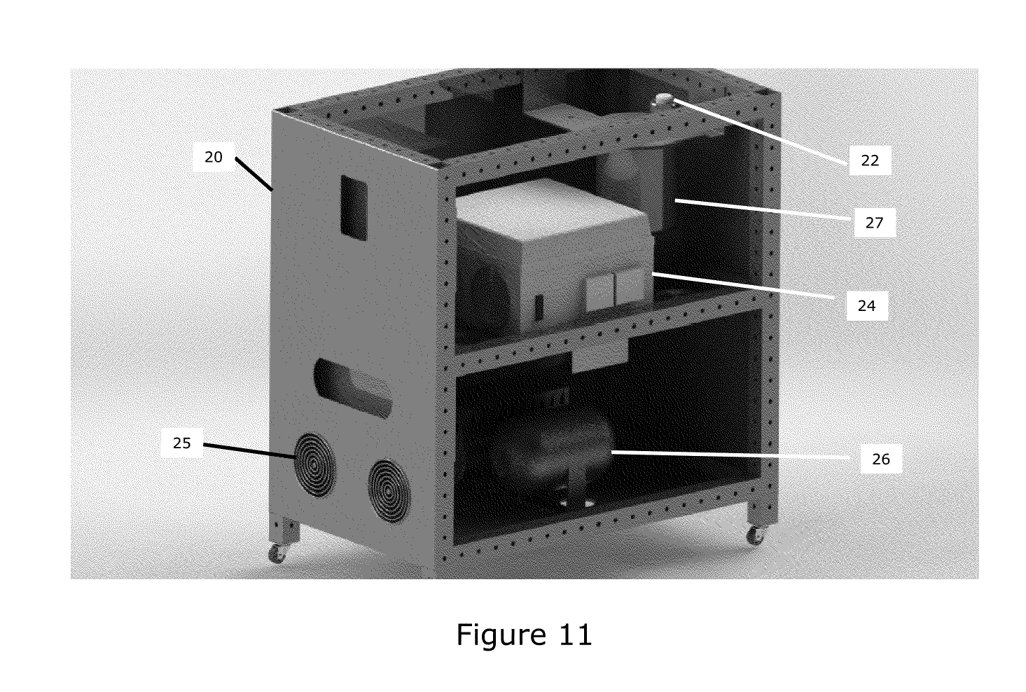

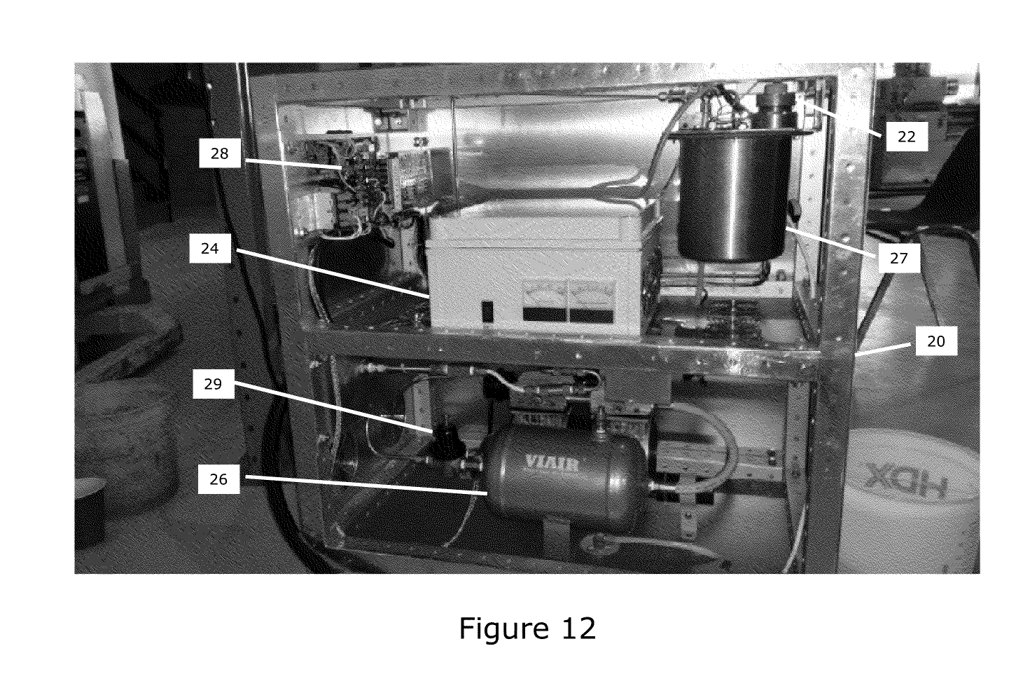

A system according to the present invention may also be provided in the form of a mobile plasma-catalytic enhanced water production unit. An illustration and photograph are provided in FIGS. 11 and 12, respectively. The mobile plasma-catalytic enhanced water production unit 20 may include a hybrid plasma discharge reactor 22, a plasma discharge power supply 24, a water pump and/or water pressure regulator (not shown), an air compressor 28, an air pressure regulator 29, and a collector 27. The system may also optionally one or more fans 25 to circulate air within the system to cool the mechanical and electronic components. The system may also include a central power distribution unit 28 designed to receive and distribute power to the various components of the system from a common location. The air compressor 28 provides air to the hybrid plasma discharge. Air may be injected tangentially in the gap between two cylindrical electrodes (not shown) and creates vortex flow. The plasma discharge power supply 24 applies high voltage to the high voltage electrodes, which establishes a potential different between the high voltage electrodes and ground electrode. The plasma discharges are initiated between the two electrodes, and the vortex flow stretches and rotates discharges and produces plasma zones inside the hybrid plasma discharge reactor 22. Water may be injected by a water pump into the plasmatron and passes through the plasma zones. The enhanced water then exits the reactor 22 and may be collected at a receiver at an outlet of the plasma system. The receiver or outlet may optionally be connected to a delivery system.

The plasma-catalytic enhanced water generated using the systems and methods of the present invention preferably have a chemical composition that provides the ideal soil pH and nutrient composition for plant water feedstock. Soil pH plays a crucial role in the development and yield of plants. For example, a pH of 6.5 is recommended for most home gardens because most plants thrive in a pH of about 6.0 to 7.0 (slightly acidic to neutral) range. Some plants (blueberries, azaleas) prefer more strongly acidic soil, while a few plants (ferns, asparagus) do best in soil that is neutral to slightly alkaline. Examples of plant pH preferences include:
pH 4.5-5.0: Ericaceae (Azalea, Bilberry, Blueberry, Cranberry, Heather, Hydrangea for blue, (less acidic for pink), Uquidambar or Sweet Gum, Orchid, Pin Oak.
pH 5.0-5.5: Boronia, Daphne, Erlcaceae: (Camellia, Heather, Rhododendron), Ferns, Iris, Orchids, Parsley, Conifers (e.g., Pine), Poaceae: (Maize, Millet, Rye, Oat), Radish, Solanales: (Potato, Sweet Potato)
pH 5.5-6.0: Asteraceae: (Aster, Endive), Brassicaceae: (Brussels sprout, Kohlrabi), Carrot, Cucurbitales: (Begonia, Chayote or Choko), Fabaceae: (Bean, Crimson Clover, Peanut, Soybean), Petunia, Rhubarb, Violet, most bulbs (Canna, Daffodil, Jonquil), Larkspur, Primrose.
pH 6.0-6.5Antirrhinum or Snapdragon, Brassicaceae: (Broccoli, Cabbage, Candytuft, Cauliflower, Turnip, Wallflower), Cucurbitaceae: (Cucumber, Pumpkin, Squash), Fabaceae: (Pea, Red Clover, White Clover), Gladiolus, Iceland Poppy, Rosales: (Cannabis, Rose, Strawberry), Solanaceae: (Eggplant or Aubergine, Tomato), Sweet corn, Violaceae: (Pansy, Viola), Zinnia or Zinnea
pH 6.5-7.0: [Amaranthaceae]: (Beet, Spinach), Apiaceae: (Celery, Parsnip), Asparagales: (Asparagus, Onion), Asteraceae: (Chrysanthemum, Dahlia, Lettuce), Carnation, Fabaceae: (Alfalfa, Sweet pea), Melons, Stock, Tulip
pH 7.1-8.0 Lilac
   The system parameters used to generate the plasma-catalytic enhanced water according to the present invention may be modified, so that the water will exit the plasma discharge with a pre-selected pH. Alternatively, the plasma-catalytic enhanced water may be diluted or post-treated to achieve the desired pH.

The degree of treatment using the systems of according to the present invention may be achieved through controlling the enthalpy. Specific energy input (SEI), also known as enthalpy, characterizes the relative energy into a media. In this case, the media is a flow of water and air and can be calculated:

$$SEI = \frac{P}{Q}$$

In this equation, P is the power of the plasma discharge [kW, kilowatts], which is provided by the plasma power supply. Furthermore, Q is the flow rate of the media. For the present invention, Q will be the flow rate of air, Qa, and the flow rate of water, Qw, and is expressed as kWh/m³ and kWh/gallon, respectively. Enthalpy of the plasma stream is preferably maintained at the lowest level necessary to obtain a desired composition. If the production of plasma-catalytic enhanced water must be scaled up, the plasma stream enthalpy and water flow rate can be increased proportionally to maintain the same ratios and consistent enhanced water composition.

Nitrates and nitrites are beneficial for plant growth. The concentration of nitrates and nitrites in the plasma-catalytic enhanced water may be controlled by the systems according to the present invention by modifying the composition of the reactants (water and gas) and the enthalpy of the system. Addition of water to the plasma gas may also result in the generation of reactive oxygen species, such as, but not limited to, hydroxyl radicals and hydrogen peroxide. These species are unstable and will exist in water for a relatively short time. Water containing these reactive oxygen species will maintain antimicrobial, antifungal, and antiviral properties while these species remain active. The concentration of these species may also be controlled by changing input composition and enthalpy of the system.

For example, if the plasma-catalytic enhanced water contains an unacceptably high concentration of nitrates and nitrites, the gas delivered to generate the plasma may be modified by increasing the nitrogen to oxygen ratio and/or treated using a more thermal discharge. If the plasma-catalytic enhanced water contains an unacceptably high concentration of H₂O₂ or dissolved ozone and Insufficient nitrates and nitrites, the composition of the gas input may be modified by lowering the nitrogen to oxygen ratio and/or treated with a less thermal discharge. In certain embodiments of the present invention, a single system may include both a more thermal plasma discharge and a less thermal plasma discharge to both balance and further enhance the water composition.

Once the plasma-catalytic enhanced water is produced, it may be stored or provided to an immediate delivery system. If the application of Interest requires only long lived nitrogen containing species, the plasma-catalytic enhanced water may be stored for extended durations and used when desired. If short lived reactive species are desired, like H₂O₂ or dissolved ozone, the plasma-catalytic enhanced water should be immediately fed to a delivery system for application. In either case, the product should be distributed to agricultural products as necessary to achieve the desired product growth and yield.

### EXAMPLES

In order that the invention may be more fully understood, the following Examples are provided by way of Illustration only.

### Example 1

### Evaluation of Plasma Generated Species in Water

A brief investigation was conducted to determine the quantity of plasma generated species in water over time. A gliding arc plasma discharge was used to treat 30 mL/min of water with an air flow rate of about 75 L/min at an average current of 200 mA, a voltage of 1.5 kV, and 300 W. The plasma-catalytic enhanced water was tested immediately and subsequent hours for the following parameters:

TN: Total Nitrogen (N) in water

TP: Total Phosphorus (P) in water

TK: Total Potassium (K) in water

H₂O₂: Hydrogen Peroxide

NO₃⁻: Nitrate

NO₂⁻: Nitrite

TH: Calcium & Magnesium Carbonates

O₃: Ozone

pH

Alkalinity

### Explanation of Parameters

1. N—P—K

Nitrogen, Phosphorus, and Potassium are the three primary nutrients found in fertilizers. They are the soil macronutrients and fertilizer companies attempt to balance and control them. Each plant prefers a specific balance of nitrogen (N), phosphorus (P), and potassium (K), and depending on the region, the nutrients will already be available, sometimes in excess, in that region's soil.

2. Total Nitrogen

The metric “total nitrogen” is used commonly in agricultural and wastewater industries to account for nitrogen compounds that are likely to be found. It accounts for the sum of ammonia-N, organic N, nitrate and nitrite. For plants, nitrogen is important for growth. It promotes lengthening of trunks and increases foliage and fruits. It is most commonly absorbed by plants in the form of nitrate NO₃⁻. Excess nitrogen can weaken a plant's structure creating an unbalanced relationship between the green parts and the wooden parts. Plants also become less resistant to diseases when soil contains too much nitrogen.

3. Total Phosphorus

Phosphorus is important for energy regulation in plant cells, which will affect the quality of seeds and the formation of buds and roots. Without enough phosphorus, plants cannot grow as fast and will produce less and/or smaller fruits. Phosphorus is taken up by plants quite slowly as it is commonly found in an organic form and must be decomposed to be useful to plants. As soil pH decreases, phosphorus will be less available to plants because it will tend to react with metals like aluminum and iron in the soil.

4. Total Potassium

Potassium affects plant quality and is often absorbed at an increased rate in the early stages of growth. It is also important for regulating energy as it is required for photosynthesis, water regulation, etc. Potassium requirements, however, vary heavily on the plant. Optimizing potassium availability is also soil-type dependent. Furthermore, potassium optimization of potassium may be difficult because it may displace other nutrients in the soil. For example, K₂O may be prevalent in warmer, slightly acidic soil, but may cause the displacement of other ions that are likely to be present like calcium or aluminum.

5. pH and Alkalinity

The pH is a measure of the presence of the hydrogen ion (H⁺). Each plant has a unique preference of pH range, as explained above, in order to increase its growth potential. In the area of agriculture, pH is useful as an indicator for what nutrients and microorganisms are available in the soil environment. Manipulating the pH can affect these factors. For plants, a pH of 6.5-7 is considered neutral and optimal for most crops; a pH of 6 is slightly acidic; a pH of 5 is strongly acidic. Alkalinity is the measure of the capacity to neutralize acids. The plasma-catalytic enhanced water made according to the present invention is acidic, and therefore, has low alkalinity and will not neutralize other acids.

6. Nitrate

Nitrate is a polyatomic ion with the molecular formula NO₃⁻ and a molecular mass of 62.0049 g/mol. The air generated plasma will produce high concentrations of NO₃⁻ that will increase over time, as other compounds in the plasma-catalytic enhanced water decomposes.

7. Nitrite

Nitrite is an ion, which has the chemical formula NO₂⁻. The air generated plasma will produce some NO₂⁻, however it is a short-lived species that will decrease over time.

8. Hydrogen Peroxide

Hydrogen peroxide has the formula H₂O₂. It is used by gardeners. Rainwater naturally contains small quantities of it. Its use is gaining popularity among marijuana growers. There is evidence for use of H₂O₂ for soil remediation. H₂O₂ oxidizes organic matter and is a primary mechanism to control infections, fungal growth, etc. The air generated plasma will produce some hydrogen peroxide in water, but it is one of the short-lived species. It most likely reacts with nitrite to form nitrate and nitric acid over time.

9. Total Hardness

Total hardness measures the presence of Ca²⁺ as CaCO₃.

Table 1 provides the concentrations of plasma generated species in the enhanced water obtained from a gliding arc discharge, as well as other parameters, over a 36 hour period.

TABLE 1

| Time | | | | H₂O₂ | NO₃ | NO₂ | TH | O₃ | | | |
|---|---|---|---|---|---|---|---|---|---|---|---|
| (hr) | TN | TP | TK | (ppm) | (ppm) | (ppm) | (ppm) | (ppm) | T (° C.) | pH | Alkalinity |
| 0.00 | med | 0 | 0 | 40.00 | 391.36 | 7.00 | 30-40 | 0.05 | 37.60 | 2.78 | 0-20 |
| 1.00 | med | 0 | 0 | 3.00 | 404.98 | 1.00 | 30-40 | 0.05 | 29.90 | 2.67 | 0-20 |
| 2.00 | — | — | — | 1.00 | 457.34 | 0.50 | 30-40 | 0.05 | 27.10 | 2.64 | 0-20 |
| 3.00 | — | — | — | 0.10 | 447.03 | 0.10 | 30-40 | 0.05 | 26.40 | 2.62 | 0-20 |
| 4.00 | — | — | — | 0.10 | 460.83 | 0.10 | 30-40 | 0.05 | 26.10 | 2.63 | 0-20 |
| 5.00 | — | — | — | 0.10 | 460.83 | 0.10 | 30-40 | 0.05 | 26.50 | 2.60 | 0-20 |
| 36.00 | med | 0 | 0 | 0.00 | 448.73 | 0.00 | 20-30 | 0.05 | 23.70 | 2.68 | 0-20 |

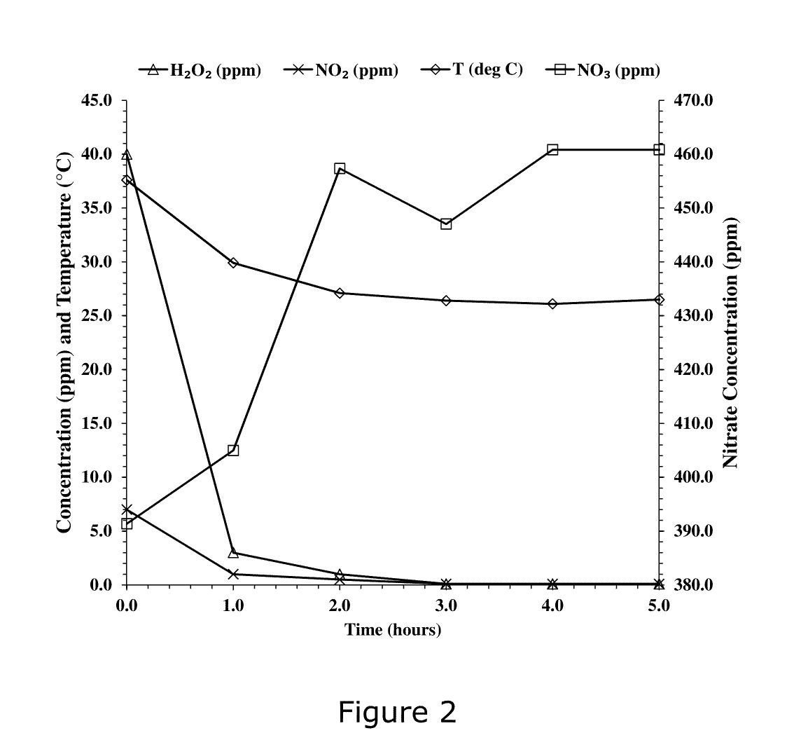

FIG. 2 provides trends for concentration of species and temperature, using the data from Table 1, as a function of time over 5 hours, along with an inset graph demonstrating pH trends over the period. Clearly, hydrogen peroxide and nitrite concentration and temperature are maximized immediately after plasma treatment. Over the period of one to two hours, these short lived species concentrations decrease by over an order of magnitude, while nitrate concentration has increased by over ten percent. At the same time, pH decreases. This trend indicates that applications, which desire the effects of short lived species, such as for fungi, viruses, and pests, the plasma catalytic enhanced water should be treated as a point of use device.

### Example 2

### Evaluation of the Effects of Specific Energy Input on the System

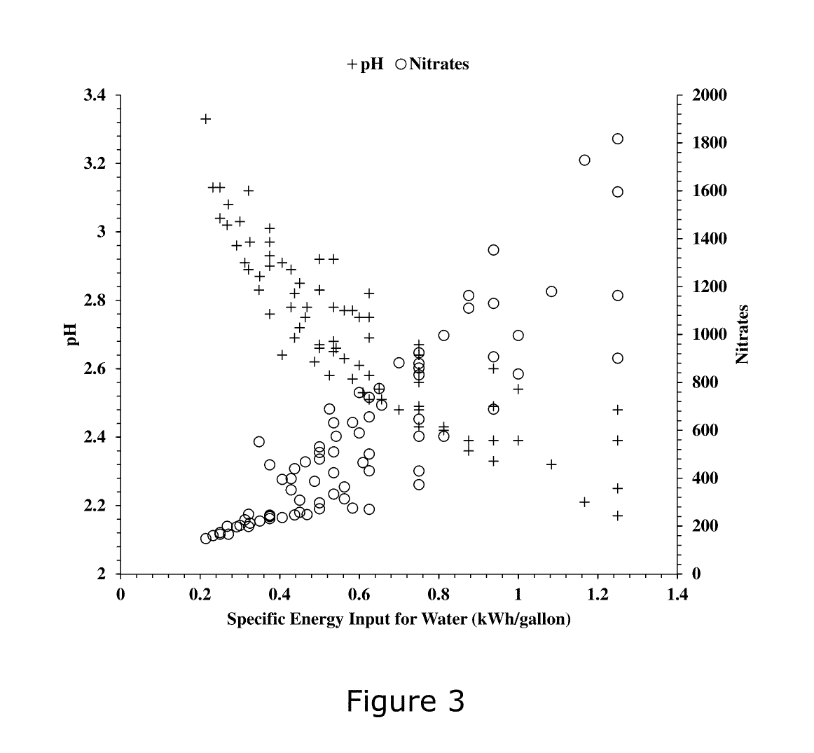

Several runs were performed varying water and air flow rate, current, and voltage for a system using a gliding arc discharge. The pH and nitrate concentration in the plasma-catalytic enhanced water was immediately tested during each run. FIG. 3 provides the trends for pH and nitrate concentration as a function of specific energy input for the plasma-catalytic enhanced water. Decreasing water flow rate, which in turn increases specific energy input for water results in an Increase in nitrate concentration and a decrease in pH. Similarly, increasing water flow rate, which in turn decreases specific energy input for water results in a decrease in nitrate concentration and an increase in pH. As such it can be used as a tunable parameter to alter water chemical composition and pH.

From the data used to generate FIG. 3, trends were generated in which only one of the specific variable tested was held constant.

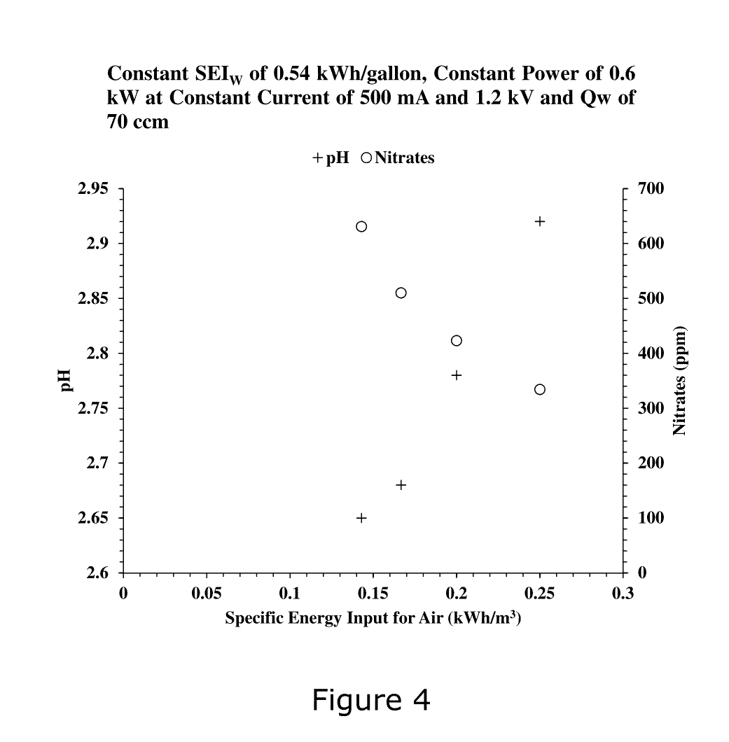

FIG. 4 provides trends for pH and nitrate concentration as a function of specific energy input for air at a constant value of specific energy input for water, 0.54 kWh/gallon. Decreasing air flow rate, which in turn increases specific energy input for air, at a constant water specific energy input, results in decrease in nitrate concentration and an increase in pH. Similarly, increasing air flow rate, which in turn decreases specific energy input for air, at a constant water specific energy input, results in an increase in nitrate concentration and a decrease in pH. As such it can be used as a tunable parameter to alter water chemical composition and pH if a desired water flow rate is specified.

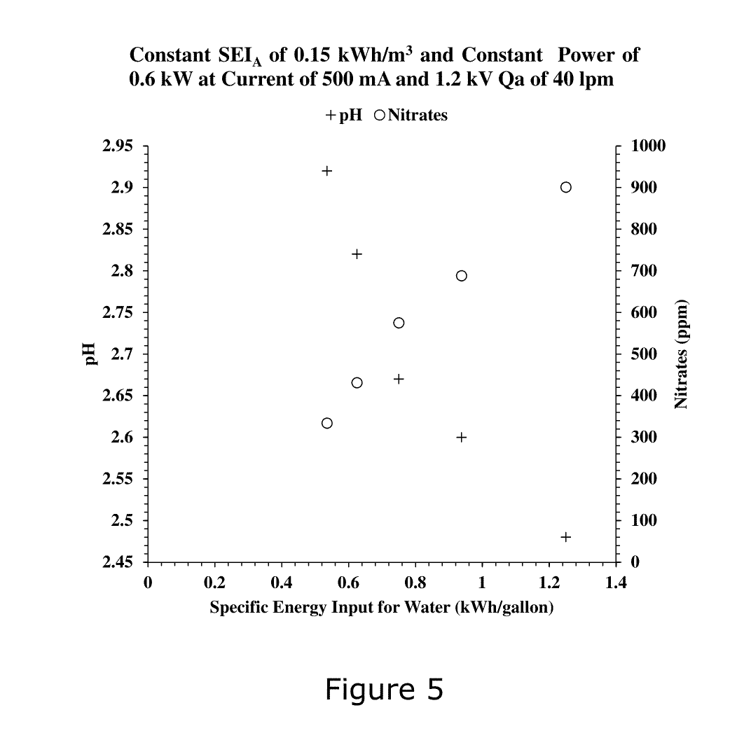

FIG. 5 provides trends for pH and nitrate concentration as a function of specific energy input for water at a constant value of specific energy input for air, 0.15 kWh/m3. Decreasing water flow rate, which in turn increases specific energy input for water, at a constant air specific energy input, results in an increase in nitrate concentration and a decrease in pH. Similarly, increasing water flow rate, which in turn decreases specific energy input for water, at a constant air specific energy input, results in a decrease in nitrate concentration and an increase in pH. As such it can be used as a tunable parameter to alter water chemical composition and pH if a desired air flow rate is specified.

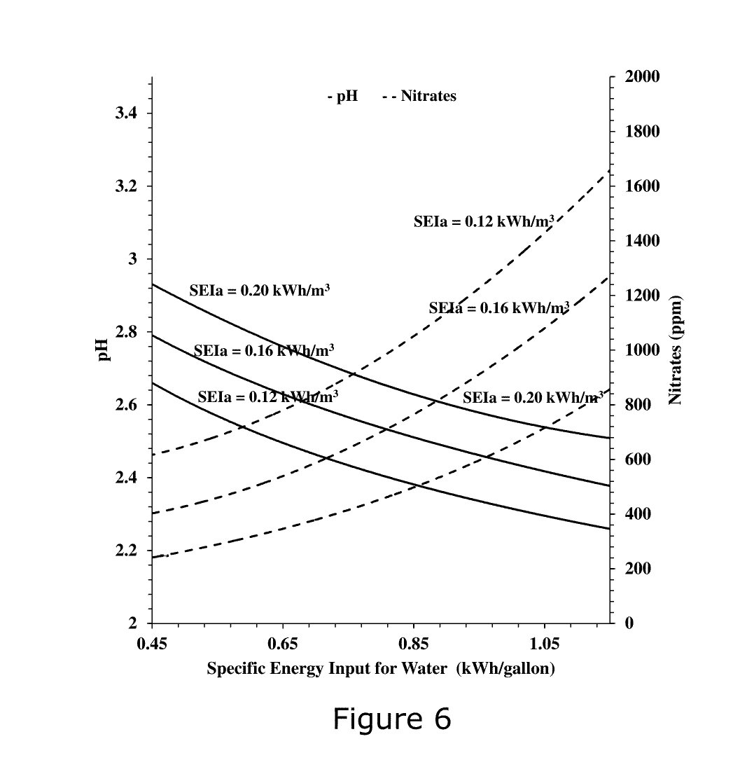

FIG. 6 provides trends for pH and nitrate concentration at varying specific energy input for water at three values of specific energy input for air. Higher specific energy input for air (lower air flow rates) results in higher pH and lower nitrates, while lower specific energy input for air (higher air flow rates) results in lower pH and higher nitrates. At the same time, increasing specific energy input for water (low water flow rate) at constant specific energy input for air results in lower pH and higher nitrates. As such, it is possible to balance the specific energy input parameters to achieve desired chemical composition and pH. Increasing specific energy input for water resulting in increased nitrate production and lower pH makes sense, as higher energy input results in a more thermal discharge, which results in an Increase NOx species production and hence decrease in pH. Decreasing specific energy input for air resulting in higher pH and lower nitrate production isn't necessarily intuitive. We assert that this trend is due to the formation of droplets, which increase the surface area of the water, resulting in Increased water surface interaction with the plasma.

### Example 3

### Power Analysis

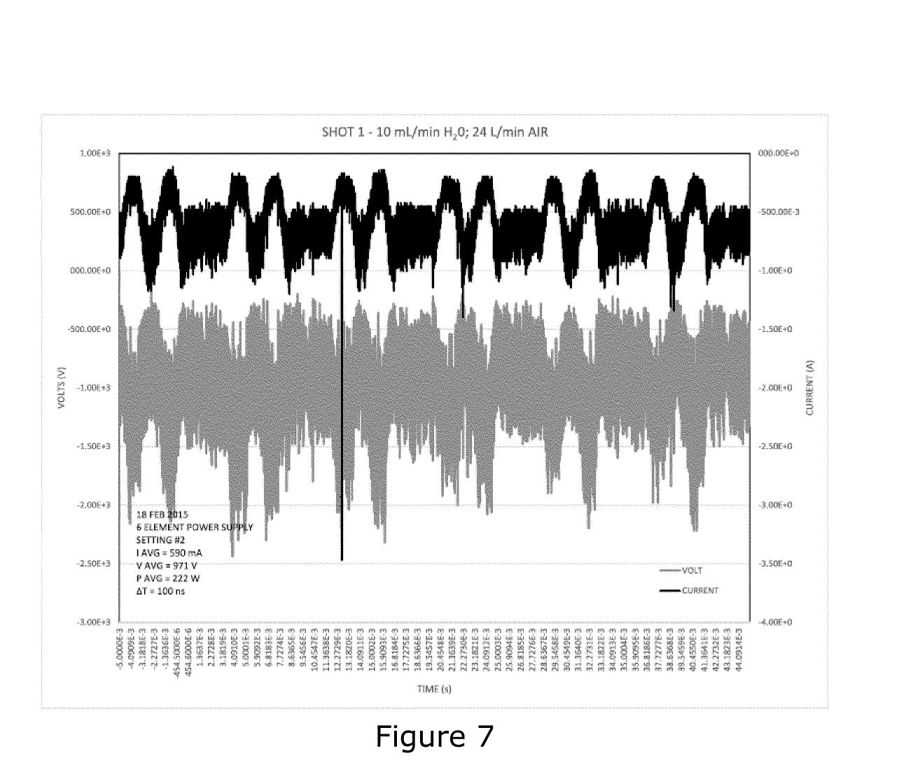

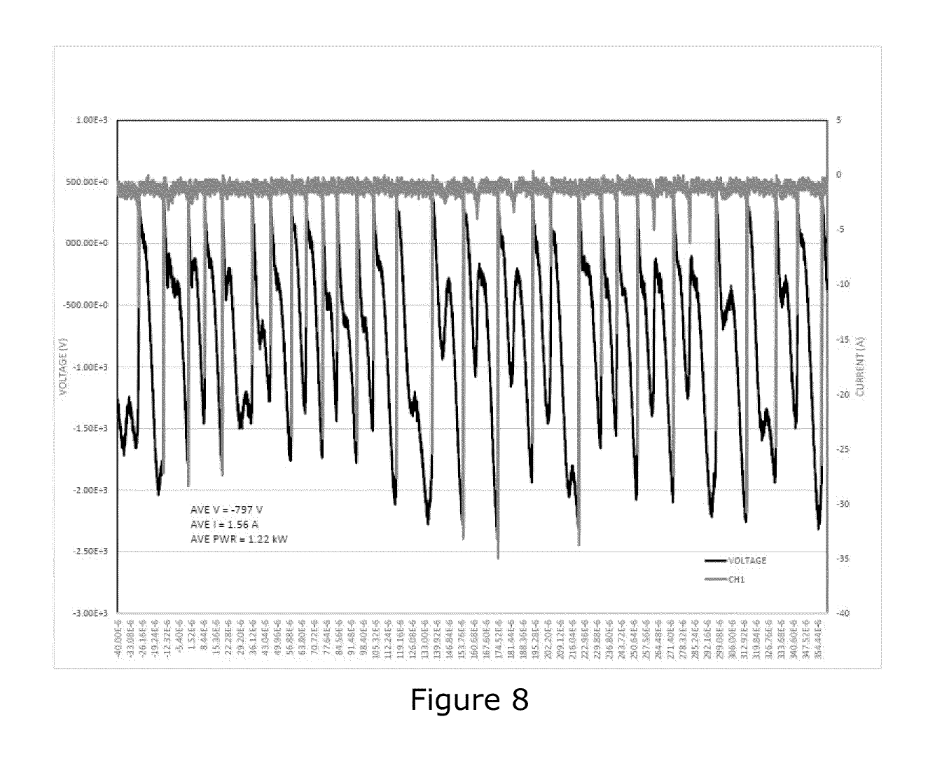

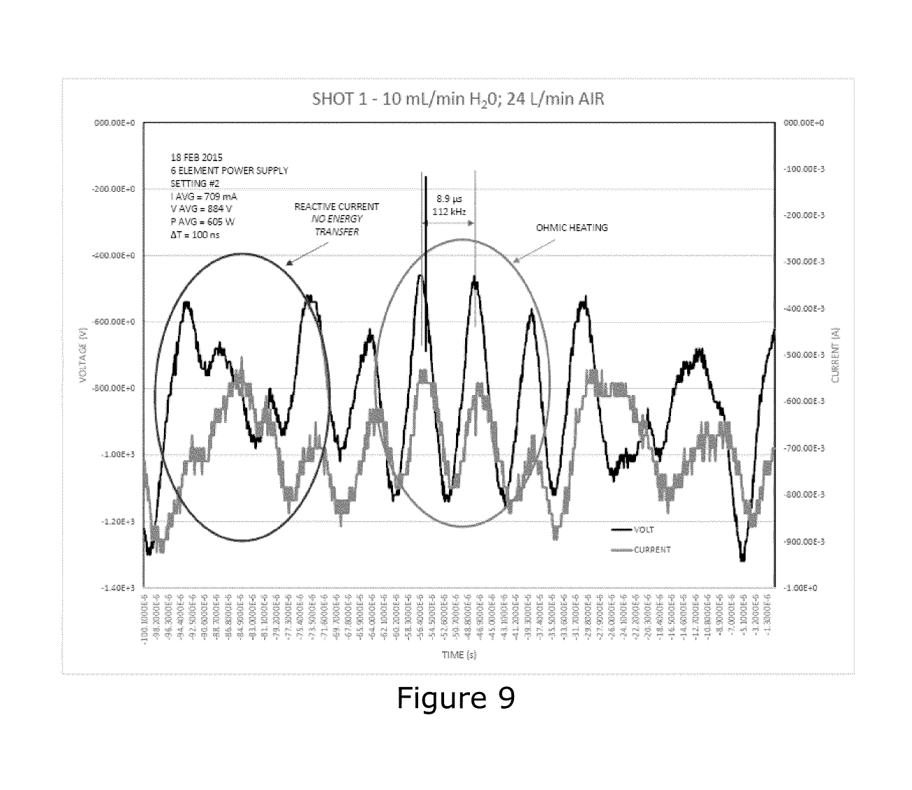

A power analysis of a system including a gliding arc discharge according to an embodiment of the present invention was performed. An oscilloscope was used to monitor the current and voltage of the plasma discharge for two settings. In the first setting, a 10 ml/min water and 24 L/mln air flow rate was used with an average power input of 222 W. In the second setting, a 24 ml/min water and 10 L/min air flow rate was used with an average power input of 1.22 kW. The current and volts over a 50 ms period using the first setting was recorded, and the data set plotted in FIG. 7. In FIG. 9, a 0.1 ms period within the 50 ms period of the first setting was plotted. The current and volts over a 0.3 ms period using the second setting was recorded and plotted in FIG. 8.

FIG. 7 demonstrates several important points. First, contrasting the plots in FIG. 7 and FIG. 8, FIG. 8 occurred in a regime where air flow was low. The resulting pH reduction of the enhanced water was very small (dose to neutral). The power deposition in FIG. 8 is five times that found in FIG. 7. In FIG. 7, a higher air flow rate demonstrated a significant drop in pH. Another major difference between FIG. 7 and FIG. 8 is the very large current events in FIG. 8, some of which reach nearly 35 amps. Such a trend makes sense for fixed impedances, where power scales as I². Even with plasma, the power will scale with the current in some form of power law.

High power deposition indicates that an arc is struck at a relatively high voltage level, and the resulting high current creates a very low resistance current channel through gas. When the power supply output capacitance voltage has been drained and the arc can no longer be sustained, the plasma is extinguished and the power supply output begins charging to the breakdown level. All of the energy has been expended on vaporizing electrodes and heating gas. In FIG. 7, which was performed at lower current and higher air flow rate and where significant pH modification is observed, the 0.1 ms period illustrated in FIG. 9 readily demonstrates ohmic power deposition, as well as reactive power as kink instabilities and plasma quenching alter the resistive and reactive component ratios of the discharge.

Arc formation takes place in tens of nanoseconds. There is no physical means to throttle this process. The current will rise to the limit allowed by system inductance and plasma resistance, therefore the difference in behavior between FIG. 8 (insignificant pH modification) and FIG. 7 and FIG. 9 (significant pH modification) is the conditions inside of the plasma discharge just prior to breakdown. As water has a dielectric constant of 80, most of the voltage stress will be in between the water droplets, the water effectively forming the plates of a capacitor. But in these examples, the water used was tap water and therefore contained pre-existing ionic compounds and the “capacitors” were connected by a relatively high resistance so that between the two potentials in the plasma discharge, a chain of resistors and capacitors effectively existed. This slows the rise and fall of the electric field in the plasma discharge, moderating the current. Eventually the electric field is sufficient to flash over, but as the field gradient has been spread out, a single arc channel is difficult to form; current diffuses through the bulk of the vapor rather than blasting a thin thread of hot plasma through it. This is why the lower power regime (higher air flow rate) is more effective—more water surface area is exposed to plasma even if the heat, UV and thermal radiation and number of ions created are less.

Furthermore, the change in pH scales with air velocity. Increasing velocity would have the tendency to lower the pressure in the plasma discharge. At lower pressures, it should be easier to ignite a plasma, but the data shows increasing rather than decreasing voltage. However, at the higher air velocities, the water transitions from droplets to an aerosol, which is the desired operational mode. This data suggests that when designing a plasma power supply and discharge reactor, total power input is less critical than water surface area and maximizing the interaction between the plasma discharge and water surface.

### Example 4

### Increasing Cannabis Sativa Yield Via Plasma-Catalytic Enhanced Water Stimulated Growth

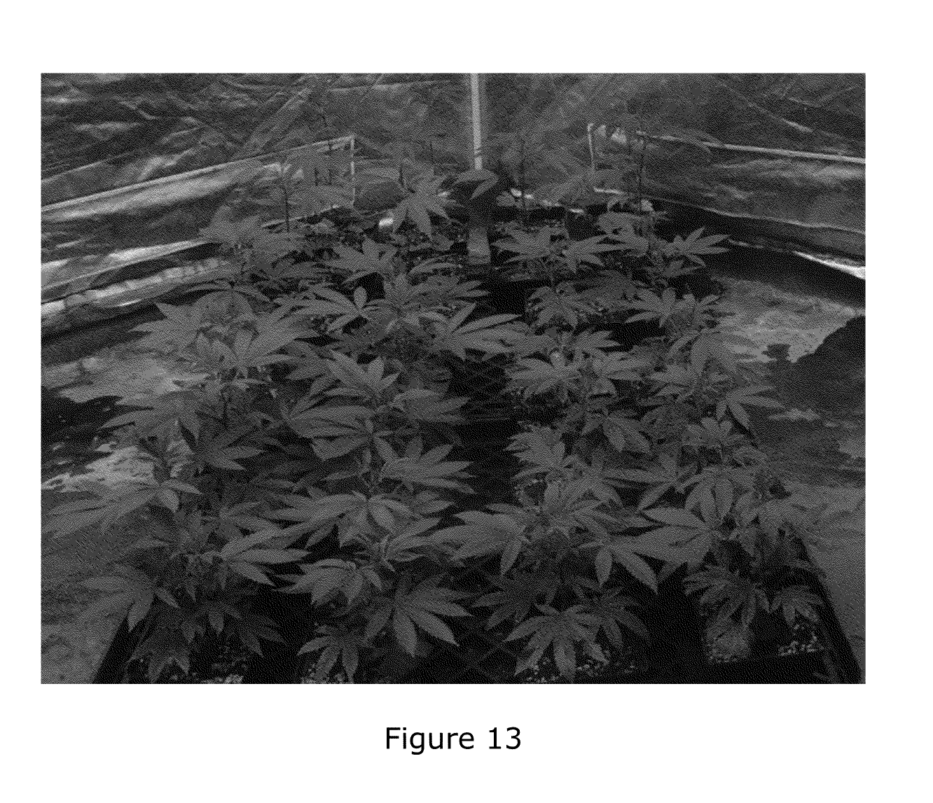

An image comparing the Cannabis Sativa grown utilizing plasma catalytic enhanced water and without utilizing plasma catalytic enhanced water is provided in FIG. 13. The Cannabis Sativa grown using plasma catalytic enhanced water has noticeably increased plant growth (height) and yield (increased leaf size and quantity).

While preferred embodiments of the invention have been shown and described herein, it will be understood that such embodiments are provided by way of example only. Numerous variations, changes, and substitutions will occur to those skilled in the art without departing from the spirit of the invention. Accordingly, it is intended that the appended claims cover all such variations as fall within the spirit and scope of the Invention.

We claim:

1. A water processing system comprising
a plasma power supply configured to regulate the plasma discharge current of a plasma discharge,
a plasma discharge reactor connected to the plasma power supply and configured to generate the plasma discharge,
a water source containing water,
a pump connected to the water source and configured to deliver the water to a nozzle, the nozzle configured to spray water into the plasma discharge,
a gas source containing a gas,
a compressor connected to the gas source and configured to deliver the gas for the plasma discharge, and
a plasma-catalytic enhanced water collector configured to collect the water after the water has passed through the plasma discharge,
wherein the water in the plasma-catalytic enhanced water collector contains a greater concentration of nitrate than the water in the water source.

2. The water processing system of claim 1, wherein the water is selected from the group consisting of tap water, spring water, deionized, and distilled water.

3. The water processing system of claim 1, wherein the gas comprises oxygen and nitrogen.

4. The water processing system of claim 1, wherein the plasma discharge reactor include at least two electrodes and the nozzle is configured to deliver the water between the at least two electrodes.

5. The water processing system of claim 4, wherein the at least two electrodes are made from a metal selected from the group consisting of gold, titanium, stainless steel, silver, and a refractory metal.

6. The water processing system of claim 1, wherein the nozzle is selected from the group consisting of a plain-orifice nozzle, a shaped-orifice nozzle, a surface impingement single-fluid nozzle, a pressure-swirl single fluid spray nozzle, a compound nozzle, an internal-mix two-fluid nozzle, and an external-mix two-fluid nozzle.

7. The water processing system of claim 1, wherein the plasma discharge includes a non-thermal plasma.

8. The water processing system of claim 1, wherein the plasma discharge is selected from the group consisting of a spark, arc, transferred arc, glow, gliding arc, corona, microwave, radio-frequency, and a dielectric barrier discharge.

9. The water processing system of claim 1, wherein the plasma discharge is a hybrid plasma discharge.

10. The water processing system of claim 9, wherein the hybrid plasma discharge comprises a gliding arc discharge and a corona discharge.

11. The water processing system of claim 1 further comprising
an additive source comprising at least one additive selected from the group consisting of hydrogen peroxide, oxygen-containing compounds, nitrogen-containing compounds, potassium-containing compounds, and phosphorus-containing compounds,
wherein the source of additives is connected to:
a) at least one of the water source and the air source and configured to deliver the at least one additive to the water or the gas;
b) the plasma discharge reactor and configured to deliver the at least one additive to the plasma discharge;
c) the plasma discharge reactor and configured to deliver the at least one additive to the water after the water has passed through the plasma discharge; or
d) the plasma-enhanced water collector and configured to deliver the at least one additive to the water.

12. The water processing system of claim 1, the water in the plasma-catalytic enhanced water collector has a lower pH than the water in the water source.

13. The water processing system of claim 1, wherein at least one of the water and the gas is delivered in an axial direction relative to an electrode in the plasma discharge reactor.

14. The water processing system of claim 1, wherein at least one of the water and the gas is delivered tangentially relative to an electrode in the plasma discharge reactor.

15. A method of making plasma-catalytic enhanced water comprising
supplying a gas to a plasma discharge reactor to generate a plasma discharge,
regulating the current of the plasma discharge with a plasma power supply, and
delivering untreated water through a nozzle and the plasma discharge to form a plasma-catalytic enhanced water containing at least one of nitrate, nitrite, hydroxyl groups, hydrogen peroxide, ozone, and peroxynitrate.

16. The method of claim 15, wherein the plasma discharge is a hybrid plasma discharge.

17. The method of claim 16, wherein the hybrid plasma discharge comprises a gliding arc discharge and a corona discharge.

18. The method of claim 15, wherein the plasma-catalytic enhanced water has a higher concentration of nitrate than the untreated water.

19. The method of claim 15 further comprising the step of
adding at least one additive to at least one of the untreated water, the gas, and the plasma-catalytic enhanced water,
the at least one additive selected from the group consisting of hydrogen peroxide, oxygen-containing compounds, nitrogen-containing compounds, potassium-containing compounds, and phosphorus-containing compounds.

20. A method of increasing plant growth or yield comprising
producing a plasma-catalytic enhanced water according to claim 15, and
delivering the plasma-catalytic enhanced water to one or more plants.

21. The water processing system of claim 1, wherein the system is provided in the form a mobile unit that further comprises a water pressure regulator to regulate the flow of water from the pump, an air pressure regulator to regulate the flow of gas to the plasma discharge reactor, one or more fans to circulate air within the system to cool the mechanical and electronic components, and a central power distribution unit configured to receive and distribute power to the various components of the system from a common location.
